(19) United States
(12) Patent Application Publication
(10) Pub. No.: US 2005/0240913 A1
(43) Pub. Date: Oct. 27, 2005

(54) Method for generating organizational structure and method for controlling authorization thereof

(76) Inventors: Mark Liu, Hsin-Tien City (TW); Chun-Hung Lin, Hsin-Tien City (TW)

Correspondence Address: J.C. Patents, Inc.;Suite 250, 4 Venture, Irvine, CA, 92618, US

(21) Appl. No.: 11/107,446

(22) Filed: Apr. 15, 2005

(30) Foreign Application Priority Data
Apr. 22, 2004 (TW) 93111204

(51) Int. Cl. G06F 9/45

(52) U.S. Cl. 717/144; 717/132; 717/162

(57) ABSTRACT

A method of generating organizational structure and a method of controlling authorization thereof are provided. The method separates an organization into a plurality of nodes and links, and defines attributes for nodes and links, so as to describe the details of nodes and links, respectively. In case an attribute of some node (link) needs to be modified, the whole organizational structure is automatically modified by only modifying the node (link) attribute without having to sequentially change all attributes.

### CROSS-REFERENCE TO RELATED APPLICATION

This application claims the priority benefit of Taiwan application serial no. 93111204, filed on Apr. 22, 2004. All disclosure of the Taiwan application is incorporated herein by reference.

### BACKGROUND OF THE INVENTION

1. Field of the Invention

The present invention relates to a method for controlling an organization, and more particularly, to a method for providing a fast, reliable, and flexible control on the organizational authorization based on different requirements.

2. Description of Related Art

Before user can use computer to access a new organizational structure, detail information regarding to company organization, product catalog or user authorization on network system have to be determined, and sequentially keyed in to computer or a database has to be generated by using these information first. Meanwhile, if some modification is intended, manual keying-in operation is inevitable for modifying the organizational structure of the computer files, which could greatly increase the cost and lower modification flexibility. Even when some portions in detail information may be duplicated or may be similar with each other, the system cannot be efficiently operated. During the keying-in process, the most extended operation is copy and paste.

In addition, such organizational structure may be performed by many projects at the same time, such that a specific portion in whole organizational structure can be processed individually. Meanwhile, since different project performs its work separately, it is common that only final output can be shared, therefore it is required to develop and process separately (for example, to key-in and to record individually). As a result, the efficiency of entire system is reduced due to duplicate works.

### SUMMARY OF THE INVENTION

The present invention is directed to a method of generating organizational structure i. In this method, according to an embodiment of the present invention, first, the organizational structure is separated into a couple of nodes and links, and then a linkage between nodes is automatically generated via a link according to the different interaction among the different nodes.

The present invention is also directed to a method of controlling organizational authorization. In this method, according to an embodiment of the present invention, all units and their connection relationship are linked together via each unit's attribute, so as to constitute the whole organizational structure. In a case when modification the organizational structure is required, only the attribute of specific unit requiring modification can be changed.

According to an embodiment of the present invention, the organizational structure is separated into nodes and links, and attributes to links and nodes are assigned for describing its details. Therefore, as long as the attribute of some specific node and/or link is modified, with the characteristics of different link with different attribute is used to link different node with different attribute, the organizational structure is automatically modified without sequential modification one of the organizational structure.

### BRIEF DESCRIPTION OF THE DRAWINGS

The accompanying drawings are included to provide a further understanding of the invention, and are incorporated in and constitute a part of this specification. The drawings illustrate embodiments of the invention, and together with the description, serve to explain the principles of the invention.

FIG. 1A is a flowchart illustrating a method of generating organizational structure according to an embodiment of the present invention.

FIG. 1B is a schematic diagram of an organizational structure according to an embodiment of the present invention.

FIG. 1C is a schematic diagram illustrating a relationship between a node and node attributes according to an embodiment of the present invention.

FIG. 2A is a flowchart illustrating a method of controlling organizational authorization according to an embodiment of the present invention.

FIG. 2B is a schematic diagram illustrating an example of modifying organizational authorization according to an embodiment of the present invention.

FIG. 3 is a schematic diagram illustrating an example of applying the method of controlling organizational authorization to a company product catalog according to an embodiment of the present invention.

FIG. 4 is a schematic diagram illustrating an example of applying the method of controlling organizational authorization to a company employee basic information organizational structure according to an embodiment of the present invention.

### DESCRIPTION OF THE EMBODIMENTS

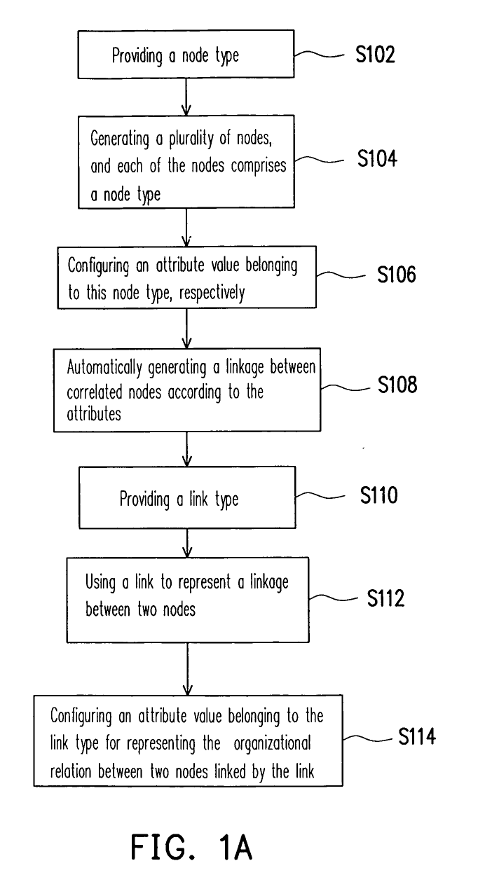

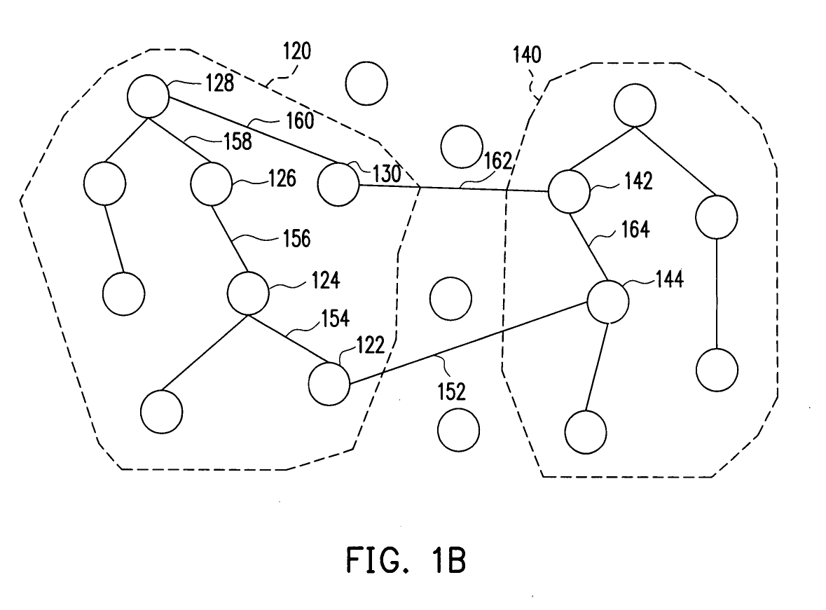

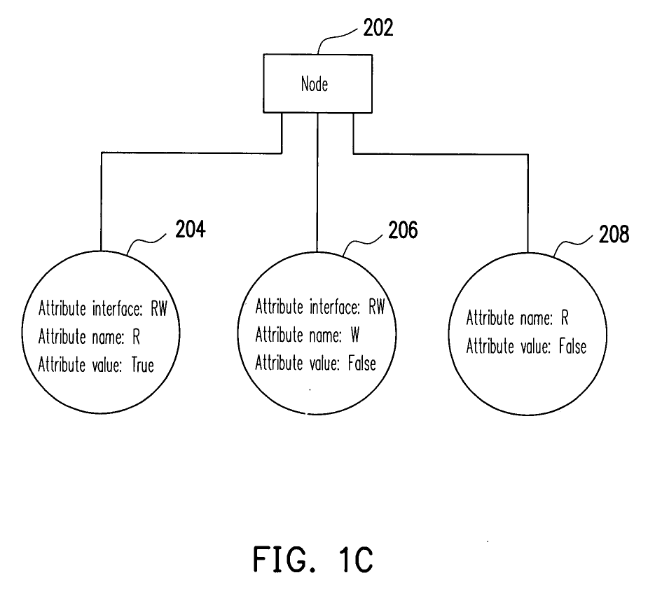

FIG. 1A is a flowchart illustrating a method of generating organizational structure according to an embodiment of the present invention. In the embodiment, a node type comprising at least one attribute is provided in step s102. Next, a plurality of corresponding nodes is generated according to the organization content by using this node type, and each node comprises a node type like this or another node type derived from such node type. In other words, each node should have a corresponding node type (a corresponding attribute in step s104. After the nodes had been generated, an attribute value is configured for the attribute of each node type respectively in step s106. Finally, a link between the corresponding nodes among nodes is automatically generated according to the attribute values in step s108.

During the generation of link between the nodes, a link type is provided first, wherein the link type comprises at least one attribute in step s110. Then, a plurality of links is generated according to the link attribute, and each link represents a linkage between two nodes and also comprises a link type in step s112. Afterwards, a value of the attribute belonged to the link type is configured for representing an organization relationship between two nodes linked by the link in step s114. For example, the attribute for each individual node type in two nodes linked by the link is configured onto each link. After all steps are completed, an organizational structure diagram as shown in FIG. 1B according to an embodiment of the present invention is obtained.

The organizational structure shown in FIG. 1B is composed of a plurality of nodes (e.g. 122, 124, 126, 128, 130, 142, 144) and a plurality of links (e.g. 152, 154, 156, 158, 160, 162, 164). Wherein, the nodes 122, 124, 126, 128, 130 and other nodes having no reference number jointly constitute an employee organization 120, and the nodes 142, 144 and other nodes having no reference number jointly constitute a database 140. The links 152, 154, 156, 158, 160, 162, 164 and the links having no reference number are used to link the nodes 122, 124, 126, 128, 130, 142, 144 and other nodes having no reference number, such that it can represent the interaction between two nodes linked by the link. Apparently, as long as the attributes of the node 128 and the node 130 are configured to correspond to node 142, the link 162 and the link 160 automatically provide the content located on the node 142 inside the database 140 (e.g. a message related to some specific work) to the node 128 and the node 130 (e.g. two employees) in the employee organization 120 without having to manually provide the related content to the employee which is represented by the node 128 and the node 130 as in the prior art.

FIG. 1C is a schematic diagram illustrating a relationship between a node and node attributes according to an embodiment of the present invention. Each of the nodes in the organizational structure mentioned above may be a node described hereinafter, however it is not necessarily limited by it. In the present embodiment, the node 202 comprises two different access interfaces, one is a read/write interface comprising node attributes 204 and 206, and the other one is a general access interface comprising a node attribute 208. It is common that each attribute comprises an attribute name (or attribute type) and its corresponding attribute value. For example, the node attribute 204 defines the attribute, which is in the “read/write interface” and related to “read”. In the node attribute 204, the value of the attribute corresponding to “read” is true, which indicates that the read operation is allowed in the node 202. On the other hand, since the attribute value of the node attribute 206 is false, by the definition of the node attribute 206, the write operation on the read/write interface is not allowed in the node 202. Similarly, by the definition of the node attribute 208, the read operation on the general access interface is not allowed in node 202 either. Obviously, by modifying the node attribute of a certain node (for example, by modifying the value of the attribute related to read from true to false), and by the characteristic of that different link links different node with different node attribute, the correlation between the peripheral node and the specific node is automatically changed (for example, the relation of sharing data read among different nodes are changed) without requiring sequential modification of each peripheral node. Specifically, when a plurality of nodes is corresponded to a same node attribute, in order to simultaneously change the link relation between the nodes and outside, modification of only one node attribute is required. Compared to the prior art, where the link relationship between each node and outside needs to be sequentially modified. Accordingly, the present invention is apparently more efficient and less expensive compared prior art.

In addition, each node may further comprise an attribute which is specifically used to represent its relation with other nodes. By using such attribute, the link relationship between the nodes is automatically and promptly formed. For example, if a value of some specific attribute indicates a department, and a value of another attribute indicates a position, the company's organizational structure is automatically generated according to different correlation among different nodes, which are represented by these two attribute values.

Moreover, an entire structure may be generated according to a same attribute type. In other words, the nodes having the same attribute type or operating interface automatically have a same/similar interaction with outside via the link corresponding to the attribute type. As a result, the organizational structure is automatically generated, and the operating relation between nodes is more meaningful with the help of the link definition.

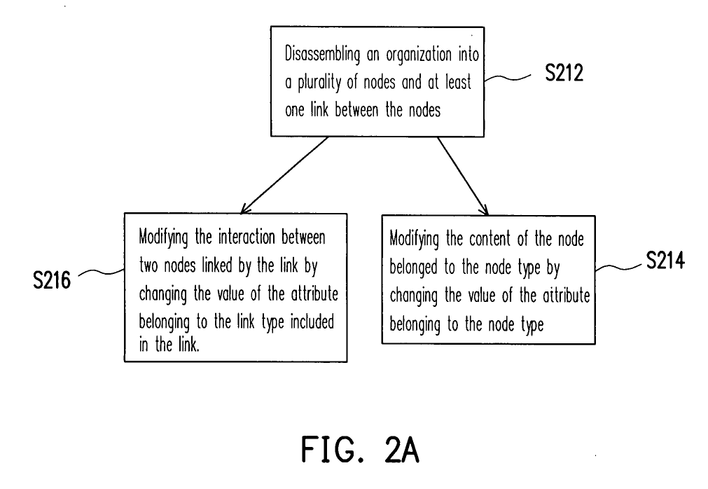

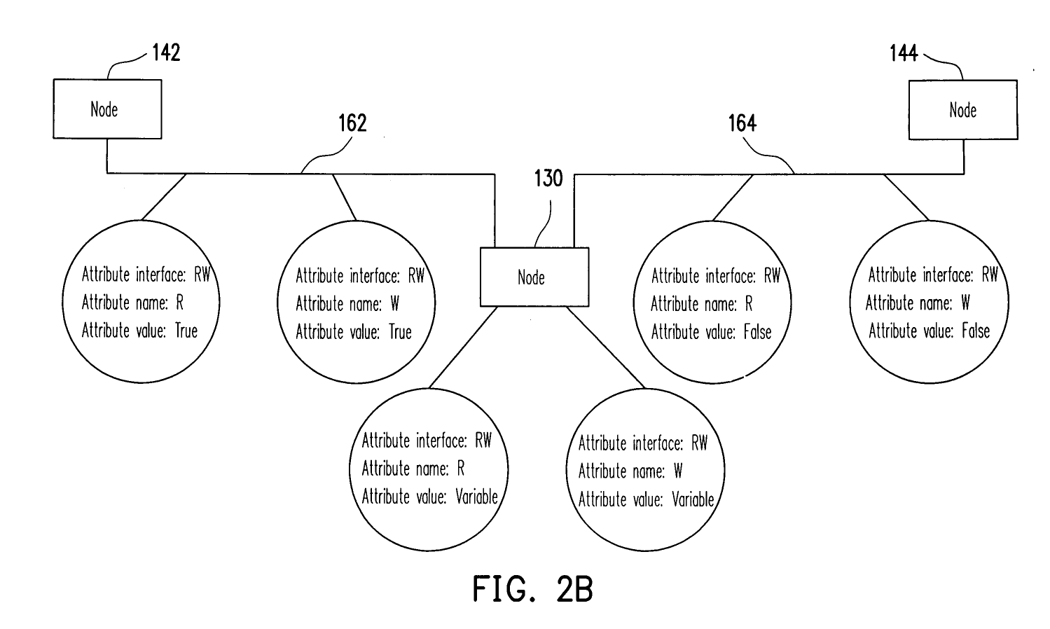

After the whole organizational structure is generated, if the modification of the interaction of some nodes is intended, instead of redesigning the whole organizational structure, the procedure shown in FIG. 2A according another embodiment of the present invention. In the method of controlling organizational authorization, according to an embodiment of the present invention, a complete organization is separated into a plurality of nodes and a plurality of links between these nodes in step s212. Wherein, at least one of the nodes comprises a node type, and at least one of the links comprises a link type.

After step s212 is completed, either the content of the node belonging to the node type is modified by changing the value of the attribute belonged to the node type in step s214 or the nodes to be linked by the link is modified by changing the value of the attribute belonged to the link type in step s216. Apparently, since the node is corresponded to the link individually (it is controlled by its individual attribute value), both contents shown in s212 and s214 change the relationship among all nodes, such that the organizational structure is automatically modified under the premise of not having to redesign the whole organizational structure.

In order to better illustrate the spirit of the invention, examples are provided hereinafter for explaining the operating procedures mentioned above. Referring to FIG. 2B, a schematic diagram illustrating an example of modifying organizational authorization according to an embodiment of the present invention is shown. In the present embodiment, originally, it is configured as that node 142 is allowed to access node 130, and node 144 is not allowed to access node 130. It is known from the operation definition mentioned above that the meaning of allowing node 142 to access node 130 means in case that node 142 intends to access node 130 via link 162, the attribute value of the access operation belonging to the corresponding attribute interface in node 130 is true. On the other hand, the meaning of not allowing node 144 to access node 130 means in case that node 144 intends to access node 130 via link 164, the attribute value of the access operation belonging to the corresponding attribute interface in node 130 is false.

In order to achieve the effect by the configuration mentioned above, in the present embodiment, an attribute value in the attribute interface RW, which is required when node 130 is operated, is specifically pointed out from the attribute types comprised in links 162 and 164. Referring to FIG. 2B, the link 162 configures the values for both read and write attributes in the attribute interface RW as true, and the link 164 configures the values for both read and write attributes in the attribute interface RW as false. In addition, the values for both read and write attributes in the attribute interface RW are configured as variable. Therefore, if node 142 intends to access node 130, the configuration in link 162 related to the attribute interface RW is written into node 130, thus node 130 can perform the read/write operation under the control of the attribute interface RW. Contrarily, if node 144 intends to access node 130, since the attribute value configured in link 164 will be written into node 130, the node 130 is not able to perform the access operation, which is controlled by the attribute interface RW.

Apparently, the attributes in both node type and link type may comprise a constant attribute and a variable attribute. Wherein, the constant attribute is basically non-changeable (for example, an employee name or date of birth, which is only modified in the rare case of the name is changed), whereas the variable attribute is changeable and may be used to modify the whole organizational structure (for example, used to modify a department name where the employee belongs to and a security level of e-mails accessible by the employee). In other words, for the node attribute, the constant attribute corresponds to the attribute of some node which does not impact the link relation between the present node and other nodes, and the variable attribute corresponds to the attribute of some node which does impact the link relation between the present node and other nodes. For the link attribute, the variable attribute corresponds to the attribute of the link which does impact the link relation between two nodes linked by the present link, and the constant attribute corresponds to the attribute of the link which does not impact the link relation between two nodes linked by the present link.

With such configuration method, it will be apparent to one of the ordinary skill in the art that if it is intended to modify the read/write authorization of node 142 or 144 onto node 130, the only thing to do is just to modify the link type attribute of the link 162 or 164. For example, the only thing to do is just exchange the value of true and false with each other for its original attribute value.

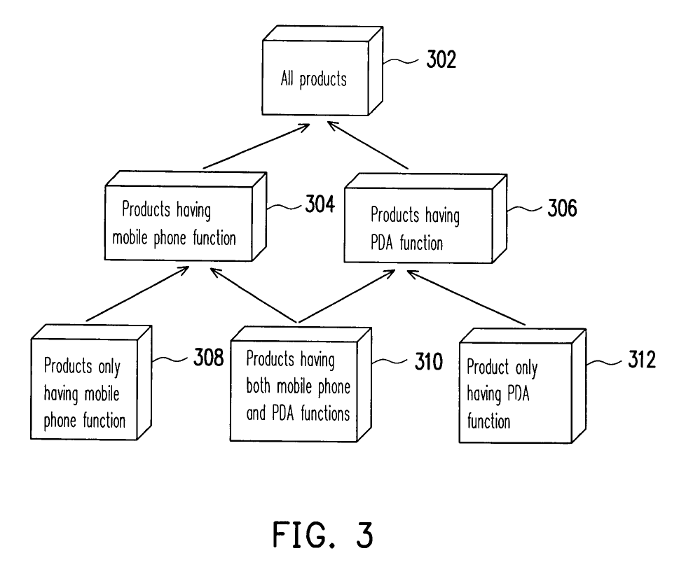

FIG. 3 is a schematic diagram illustrating an example of applying the method of controlling organizational authorization onto a company product catalog according to a preferred embodiment of the present invention.

Since some product in company may have the same function as others, when both the single function product and the multifunction product are displayed together, the products should be organized first by applying the steps illustrated in FIG. 1A, so as to obtain a structure as shown in FIG. 3.

In the present embodiment, block 302 represents all products, block 304 represents products having mobile phone function, block 306 represents products having PDA (Personal Digital Assistant) function, block 308 represents products only having mobile phone function, block 310 represents products having both mobile phone and PDA functions, and block 312 represents products only having PDA function. Wherein, block 302 may be regarded as a root node, and a first node type contained in the root node 302 comprises various product types which are used as its attributes, for example, mobile phone and PDA, etc. Block 304 and block 306 both comprise the first node type same as block 302 has, and the value of the attributes belonged to block 304 and block 306 are both assigned as a value of true when it is generated, respectively. Therefore, since blocks 304 and 306 and root node 302 all have the same node type, with the method provided by the present invention, the link relation between nodes can be automatically generated.

Furthermore, besides the first node type mentioned above, block 304 may further comprise a second node type. Wherein, the second node type may, for example, comprise an attribute, which indicates whether or not this product belongs to mobile phone type product. Similarly, blocks 308 and 310 also comprise the second node type, and since both blocks have the same mobile phone function, the values of the attributes which indicate whether or not this product belongs to mobile phone product for blocks 308 and 310 are both assigned with a value corresponding to true. Therefore, since blocks 304, 308 and 310 all have the same node type, and the value of a specific attribute in blocks 308 and 310 (here, it is an attribute for indicating whether or not this product belongs to mobile phone type product) is assigned as a value of true, such that a link relation as shown in FIG. 2B can be automatically generated based on it. Similarly, blocks 306, 310, and 312 all comprise a third node type, and the third node type comprises an attribute which indicates whether or not this product belongs to PDA type product. In addition, the values of the attributes for indicating whether or not this product belonging to PDA type product in blocks 310 and 312 are both assigned as a value of true. Therefore, the link relation as shown in FIG. 2B can be generated among blocks 306, 310 and 312 automatically.

Besides the methods mentioned above, other implementation method similar to this may be derived by one of the ordinary skill in the art based on the spirit of the present invention. For example, blocks 308, 310 and 312 may comprise both the second node type and the third node type mentioned above. However, the value of the attribute for indicating whether or not this product belongs to mobile phone type product in block 308 should be assigned as a value of true, and the value of the attribute for indicating whether this product belonging to PDA phone type product or not in block 308 should be assigned as a value of false. Therefore, it is possible to only link block 308 and block 304 according to the value of the attributes.

In the present embodiment, it is known from the structure shown in FIG. 3 that products (block 302) provided by this company comprise mobile phones (block 304) and PDA (block 306). The products having mobile phone function comprise the products only having mobile phone function (block 308) as well as the products having both mobile phone and PDA functions (block 310). The products having PDA function comprise the products having both mobile phone and PDA functions (block 310) as well as the products only having PDA function (block 312). Therefore, it is easy to understand products and functions thereof provided by the company, so that the decision maker of this company can determine company's future trend according to product functions. In addition, by applying the present invention, different product lines can share a same database, especially for the products belonging to different product lines, it is not required any more to build up its own related data under each product line individually. Apparently, it simplifies and reduces the cost for generating and maintaining the related database.

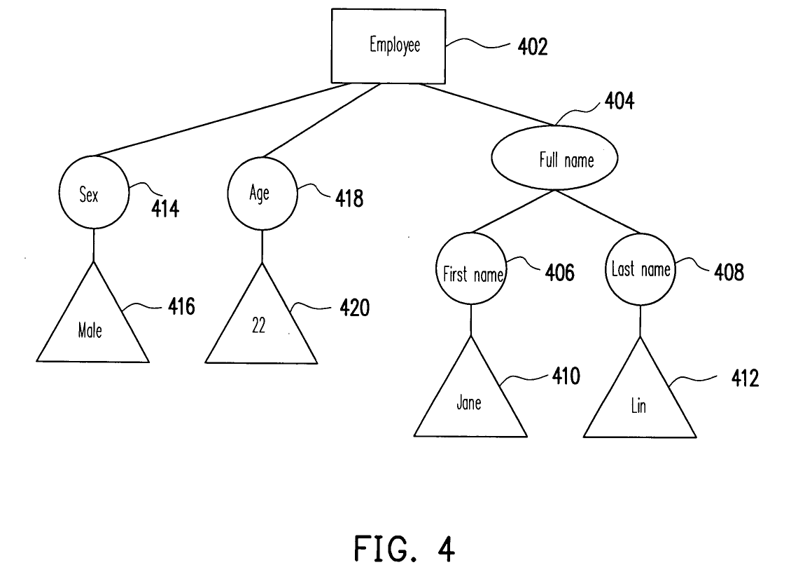

A type of employee shown in FIG. 4 may be used when the method of generating organizational structure is applied to manage the basic information of company's employees. In the present embodiment, an employee 402 may be regarded as a node type, and sex 414 and age 418 may be regarded as the attributes of such node type. An attribute value 416 under the sex attribute 414 for indicating male or female may be regarded as an attribute value of the employee 402. Similarly, a number 22 under the age attribute 418 is also one of the attribute values of the employee 402. In the present embodiment, under the employee 402, there is also a full name 404 (e.g. an attribute set), and a first name 406 and a last name 408 may be regarded as the attributes in the attribute set 404 (of course, they are also the attributes under the employee 402). Apparently, these different attributes provide different channels for configuring different positions in company for employee, for example, configuring the insurance policy according to the age attribute, or ranking and configuring position in internal address book according to the name attribute.

Besides the embodiments mentioned above, the method of generating organizational structure and the method of controlling organizational authorization provided by the present invention can be further applied on such as company's organizational structure (defining employee in organization and basic information associated with it), product catalog, file and network system (e.g. the access right of the database), etc.

Furthermore, an organizational structure management system, according to an embodiment of the present invention is provided. The management system comprises a node lump comprising of a plurality of nodes, wherein each of the nodes comprises at least one node type, and each of the node types comprises at least one attribute; a link lump comprising a plurality of links, wherein each of the links comprises at least one link type, and each of the link types comprises at least one attribute; and a process lump for modifying a value for each attribute, so as to change the relationship between the nodes and the links and to generate and modify the whole organizational structure. Here, the process lump changes the relation between the nodes and the links or either modifies the content of the node belonged to the node type by changing the value of the attribute in each of the node types or modifies the interaction between two nodes linked by the link by changing the value of the attribute in each of the links.

A storage media is provided according to yet another preferred embodiment of the present invention for storing a plurality of program codes which is used by a computer to manage the organizational structure. The program codes comprise a node program code which is used by the computer to store a plurality of message of nodes, wherein each of the nodes comprises at least one node type, and each of the node types comprises at least one attribute; a link program code which is used by the computer to store a plurality of message of links, and the link program code comprises a plurality of links, wherein each of the links comprises at least one link type, and each of the links types comprises at least one attribute; and a process program code which is used by the computer to change a value of each of the attributes, so as to modify the relation between the nodes and the links and to further generate and modify the whole organizational structure.

Since detail information had been described in the embodiments mentioned above, the detail explanation is omitted in the system and storage media embodiments herein.

Although the invention has been described with reference to a particular embodiment thereof, it will be apparent to one of the ordinary skill in the art that modifications to the described embodiment may be made without departing from the spirit of the invention. Accordingly, the scope of the invention will be defined by the attached claims not by the above detailed description.

1. A method of generating an organizational structure, comprising:
generating a plurality of nodes, wherein each of the nodes comprises a corresponding node type, and each of the node types comprises at least one attribute;
configuring an attribute value to the attribute belonging to the node type, respectively; and
automatically generating a link between the nodes according to the attribute values.

2. The method of generating the organizational structure of claim 1, further comprising:
generating a plurality of links, wherein each of the links comprises a corresponding link type, and each of the link types comprises at least one attribute;
using a link to represent a linkage between the two nodes, wherein the link comprises the link type; and
configuring an attribute value to the attribute belonging to the link type included in one of the links for indicating a relation between the two nodes linked by the link.

3. The method of generating the organizational structure of claim 1, wherein the node type of each of the nodes comprises at least one constant attribute and at least one variable attribute respectively, wherein the constant attribute corresponds to an attribute of the node which does not impact a link relationship between the present node and other nodes, and the variable attribute corresponds to an attribute of the node which does impact a link relationship between the present node and other nodes.

4. The method of generating the organizational structure of claim 1, wherein the link type of each of the links comprises at least one constant attribute and at least one variable attribute respectively, wherein the constant attribute corresponds to an attribute of the link which does not impact a link relationship between the two nodes linked by the present link, and the variable attribute corresponds to an attribute of the link which does impact a link relationship between the two nodes linked by the present link.

5. A method of controlling an organizational authorization, comprising:
disassembling an organization into a plurality of nodes and at least one link linked between the nodes, wherein at least one of the nodes comprises a node type having at least one attribute, and the at least one link comprises a link type having an attribute; and
modifying the organization by changing the attribute value of any one of the attributes.

6. The method of controlling the organizational authorization of claim 5, wherein a content of the node belonged to the node type is modified by changing the value of the attribute belonged to each of the node types.

7. The method of controlling the organizational authorization of claim 5, wherein an interaction between the two nodes linked by the link is modified by changing the value of the attribute belonging to each of the link types.

8. The method of controlling the organizational authorization of claim 5, wherein the node type of each of the nodes comprises at least one constant attribute and at least one variable attribute respectively, wherein the constant attribute corresponds to an attribute of the node which does not impact a link relationship between the present node and other nodes, and the variable attribute corresponds to an attribute of the node which does impact a link relationship between the present node and other nodes.

9. The method of controlling the organizational authorization of claim 5, wherein the link type of each of the links comprises at least one constant attribute and at least one variable attribute respectively, wherein the constant attribute corresponds to an attribute of the link which does not impact a link relationship between the two nodes linked by the present link, and the variable attribute corresponds to an attribute of the link which does impact a link relationship between the two nodes linked by the present link.

10. The method of controlling the organizational authorization of claim 5, further comprising modifying the attribute corresponding to a second node by changing the attribute value of a first link when entering into the second node from a first node via the first link.

11. An organizational structure management system, comprising:
a node lump, comprising a plurality of nodes, wherein each of the nodes comprises at least one node type, and each of the node types comprises at least one attribute;
a link lump, comprising a plurality of links wherein each of the links comprises at least one link type, and each of the link types comprises at least one attribute; and
a process lump, for changing an attribute value of each of the attributes and further changing a relationship between the nodes and the links so as to generate and modify the whole organizational structure.

12. The organizational structure management system of claim 11, wherein the process lump modifies a content of the node belonged to the node type and further modifies a relationship between the nodes and the links by changing the value of the attribute belonged to each of the node types.

13. The organizational structure management system of claim 11, wherein the process lump modifies an interaction between the nodes linked by the link and further modifies the relationship between the nodes and the links by changing the value of the attribute belonged to each of the link types.

14. The organizational structure management system of claim 11, wherein the node type of each of the nodes in the node lump comprises at least one constant attribute and at least one variable attribute respectively, wherein the constant attribute corresponds to an attribute of the node which does not impact a link relationship between the present node and other nodes, and the variable attribute corresponds to an attribute of the node which does impact a link relationship between the present node and other nodes.

15. The organizational structure management system of claim 11, wherein the link type of each of the links in the link lump comprises at least one constant attribute and at least one variable attribute respectively, wherein the constant attribute corresponds to an attribute of the link which does not impact a link relationship between the two nodes linked by the present link, and the variable attribute corresponds to an attribute of the link which does impact a link relationship between the two nodes linked by the present link.

16. The organizational structure management system of claim 11, wherein the process lump determines each of the nodes should correspond to which node having which node attribute value and determines each of the nodes should correspond to which link having which link type.

17. The organizational structure management system of claim 11, wherein the process lump determines each of the links should link which attribute having which node attribute according to the link attribute value of the link.

18. A storage media for storing a plurality of program codes used by a computer to execute an organizational structure management, the program codes comprising:
a node program code, used by the computer to store a plurality of messages of the nodes, wherein each of the nodes comprises at least one node type, and each of the node types comprises at least one attribute;
a link program code, used by the computer to store a plurality of messages of the links, wherein each of the links comprises at least one link type, and each of the link types comprises at least one attribute; and
a process program code, used by the computer to change an attribute value of each of the attributes for modifying a relation between the nodes and the links and for further generating and modifying the whole organizational structure.

19. The storage media of claim 18, wherein the node type of each of the nodes comprises at least one constant attribute and at least one variable attribute respectively, wherein the constant attribute corresponds to an attribute of the node which does not impact a link relationship between the present node and other nodes, and the variable attribute corresponds to an attribute of the node which does impact a link relationship between the present node and other nodes; and the link type of each of the links may comprises at least one constant attribute and at least one variable attribute respectively, wherein the constant attribute corresponds to an attribute of the link which does not impact a link relationship between the two nodes linked by the present link, and the variable attribute corresponds to an attribute of the link which does impact a link relationship between the two nodes linked by the present link.

20. The storage media of claim 18, wherein the process program code is used by the computer to determine each of the nodes should correspond to which node having which node attribute value and which link having which link attribute value according to the node attribute value of the nodes, and the process program code is further used by the process lump to determine each of the links should link to which attribute having which node attribute according to the link attribute value of the links.
